(19) United States
(12) Patent Application Publication
(10) Pub. No.: US 2024/0326542 A1
(43) Pub. Date: Oct. 3, 2024

(54) DRIVE UNIT

(71) Applicant: EXEDY Corporation, Osaka (JP)

(72) Inventor: Taichi KITAMURA, Osaka (JP)

(21) Appl. No.: 18/598,183

(22) Filed: Mar. 7, 2024

(30) Foreign Application Priority Data
Mar. 28, 2023 (JP) 2023-052116
Nov. 20, 2023 (JP) 2023-196630

(51) Int. Cl. B60G 17/02; B60G 7/00

(52) U.S. Cl. CPC B60G 17/02; B60G 7/001

(57) ABSTRACT

A drive unit as disclosed is capable of changing the magnitude of a wheel pressure acting on a drive wheel in accordance with the weight of a mobile object. A link mechanism includes a first link, a second link, and a first joint. The first link is pivotably attached to an upper unit. The first link extends from the upper unit both downward and in a second direction that is oriented opposite to a first direction. The second link is pivotably attached to a lower unit. The second link extends from the lower unit both upward and in the second direction. The first joint connects the first and second links therethrough to each other. An operating member is configured to move the first joint in the first direction when a human drive force is inputted thereto in the first direction.

### CROSS-REFERENCE TO RELATED APPLICATIONS

This application is based on and claims the priority benefit of Japanese application Nos. 2023-052116, filed on Mar. 28, 2023, and 2023-196630, filed on Nov. 20, 2023, the contents of which are incorporated herein by reference.

### TECHNICAL FIELD

The claimed invention relates to a drive unit.

### BACKGROUND

There has been proposed a type of drive unit attached to a mobile object such as a cart without a drive source. For example, Publication of Japan Patent No. 7040738 discloses a drive unit including an electric motor and a drive wheel driven by the electric motor. Additionally, the drive unit includes a pressure-receiving spring member by which a wheel pressure acts on the drive wheel. The pressure-receiving spring member urges the drive wheel toward the road surface such that the wheel pressure acts on the drive wheel, whereby spinning of the drive wheel is prevented.

When the mobile object is lightweight with respect to the setting of the spring member in the drive unit configured as described above, floating of a vehicle wheel of the mobile object is a concern. On the other hand, when the setting of the spring member is made in accordance with the lightweight mobile object, if the mobile object is heavy, the wheel pressure acting on the drive wheel by the spring member is insufficient, whereby spinning of the drive wheel is a concern.

### SUMMARY OF THE INVENTION

It is an object of the claimed invention to provide a drive unit enabled to change the magnitude of a wheel pressure acting on a drive wheel in accordance with the weight of a mobile object.

A drive unit according to a first aspect is configured to be attached to a mobile object enabled to travel in a first direction. The drive unit includes an upper unit, a lower unit, a drive source, a link mechanism, and an operating member. The upper unit is configured to be attached to the mobile object. The lower unit includes a drive wheel. The lower unit is disposed to be movable in an up-and-down direction with respect to the upper unit. The drive source is configured to drive the drive wheel. The link mechanism includes a first link, a second link, and a first joint. The first link is pivotably attached to the upper unit. The first link extends from the upper unit both downward and in a second direction that is oriented opposite to the first direction. The second link is pivotably attached to the lower unit. The second link extends from the lower unit both upward and in the second direction. The first joint connects the first and second links therethrough to each other. The operating member is configured to move the first joint in the first direction when a human drive force is inputted thereto in the first direction.

According to the configuration, when a user inputs a human drive force to the operating member in the first direction to make the mobile object travel in the first direction, the first joint is moved in the first direction, whereby the upper end of the first link and the lower end of the second link are moved apart from each other. In other words, forces act on the upper and lower units in directions that cause the upper and lower units to move apart from each other. As a result, a wheel pressure acts on the drive wheel. When the mobile object is heavy, the human drive force, inputted by the user to the operating member, is increased in magnitude, whereby the wheel pressure acting on the drive wheel is increased in magnitude as well. On the other hand, when the mobile object is relatively lightweight, the human drive force, inputted by the user to the operating member, is reduced in magnitude, whereby the wheel pressure acting on the drive wheel is reduced in magnitude as well. Thus, it is made possible to change the magnitude of the wheel pressure acting on the drive wheel in accordance with the weight of the mobile object.

A drive unit according to a second aspect relates to the drive unit according to the first aspect and is configured as follows. The link mechanism includes a third link, a fourth link, and a second joint. The third link is pivotably attached to the upper unit. The third link extends from the upper unit both downward and in the first direction. The fourth link is pivotably attached to the lower unit. The fourth link extends from the lower unit both upward and in the first direction. The second joint connects the third and fourth links therethrough to each other. The operating member is configured to move the second joint in the second direction when the human drive force is inputted thereto in the second direction.

According to the configuration, when the user inputs the human drive force to the operating member in the second direction to make the mobile object travel in the second direction, the second joint is moved in the second direction, whereby the upper end of the third link and the lower end of the fourth link move apart from each other. In other words, forces act on the upper and lower units in directions that cause the upper and lower units to move apart from each other. As a result, the wheel pressure acts on the drive wheel. When the mobile object is heavy, the human drive force, inputted by the user to the operating member, is increased in magnitude, whereby the wheel pressure acting on the drive wheel is increased in magnitude as well. On the other hand, when the mobile object is relatively lightweight, the human drive force, inputted by the user to the operating member, is reduced in magnitude, whereby the wheel pressure acting on the drive wheel is reduced in magnitude as well. Thus, similarly when the mobile object is caused to travel in the second direction, it is made possible to change the magnitude of the wheel pressure acting on the drive wheel in accordance with the weight of the mobile object.

A drive unit according to a third aspect relates to the drive unit according to the first or second aspect and further includes an urging member. The urging member urges the upper and lower units apart from each other.

A drive unit according to a fourth aspect relates to the drive unit according to any of the first to third aspects and is configured as follows. The operating member includes a first contact surface oriented in the first direction. The first contact surface opposes either the first joint or a member unitarily moved with the first joint in the first direction.

A drive unit according to a fifth aspect relates to the drive unit according to the second aspect and is configured as follows. The operating member includes a second contact surface oriented in the second direction. The second contact surface opposes either the second joint or a member unitarily moved with the second joint in the second direction.

Overall, according to the claimed invention, it is made possible to change the magnitude of the wheel pressure acting on the drive wheel in accordance with the weight of the mobile object.

### BRIEF DESCRIPTION OF THE DRAWINGS

FIG. 1 is a schematic diagram of a drive unit in accordance with the claimed invention.

FIG. 2 is a schematic diagram showing a state of the drive unit made in traveling in a first direction.

FIG. 3 is a schematic diagram showing a state of the drive unit made in traveling in a second direction.

FIG. 4 is a schematic diagram of a drive unit according to a modification.

FIG. 5 is a schematic diagram of a drive unit according to another modification.

FIG. 6 is a schematic diagram of a drive unit according to yet another modification.

FIG. 7 is a schematic diagram of a drive unit according to a still further modification.

### DETAILED DESCRIPTION

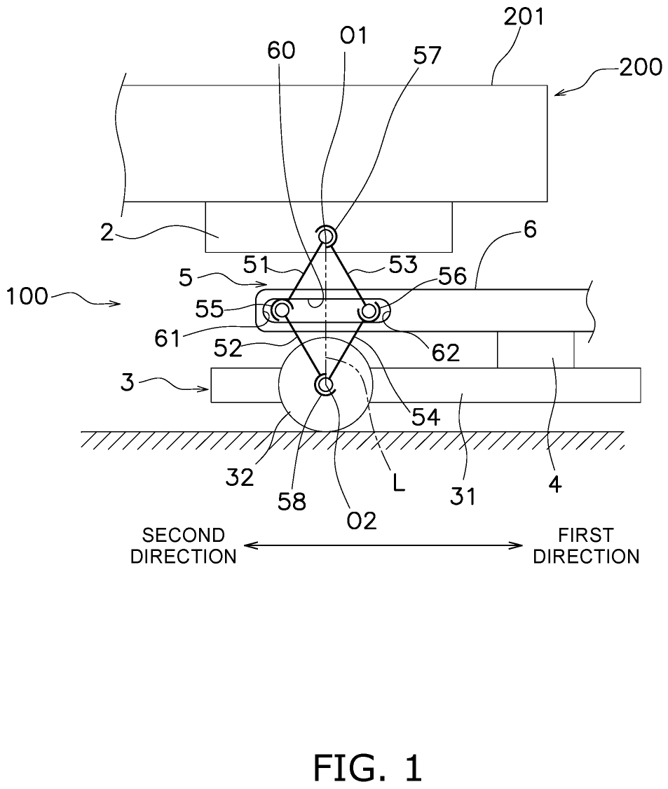

A drive unit 100 according to the presently preferred embodiment will be hereinafter explained with reference to drawings. FIG. 1 is a side view of the drive unit 100 attached to a cart 200 (exemplary mobile object). In the presently preferred embodiment, the term “first direction” refers to a direction of traveling made in towing the drive unit 100, whereas the term “second direction” refers to a direction of traveling made in pushing the drive unit 100. When using the drive unit 100, a user is located on the first-directional side of the drive unit 100. It should be noted that the right direction in FIG. 1 corresponds to the first direction, whereas the left direction in FIG. 1 corresponds to the second direction. On the other hand, the term “axial direction” refers to an extending direction of a rotational axis of a drive wheel 32.

As shown in FIG. 1, the drive unit 100 is attached to the cart 200. The cart 200 includes a bed 201 and a plurality of vehicle wheels (omitted in illustration). The cart 200 is a mobile object without a drive source such as an electric motor. The vehicle wheels of the cart 200 are driven wheels. When towed by the user, the cart 200 is enabled to travel in the first direction. On the other hand, when pushed by the user, the cart 200 is enabled to travel in the second direction. It should be noted that the drive unit 100 is attachable not only to the cart but also to a variety of mobile objects such as a stretcher, a cage cart, a wheelchair, etc.

The drive unit 100 is configured to be attached to the cart 200. The drive unit 100 includes an upper unit 2, a lower unit 3, an electric motor 4 (exemplary drive source), a link mechanism 5, and an operating member 6.

The upper unit 2 is configured to be attached to the cart 200. For example, the upper unit 2 may include at least one toggle clamp and may be attached to the cart 200 with the toggle clamp(s). Alternatively, the upper unit 2 may be attached to the cart 200 by at least one bolt and/or so forth. The upper unit 2 is fixed to the cart 200 to be unitarily moved therewith. It should be noted that the upper unit 2 is shown as being disposed below the cart 200, but it may be disposed at a position other than below the cart 200.

The lower unit 3 includes a frame 31 and a pair of drive wheels 32. The drive wheels 32 are rotatably supported by the frame 31. The lower unit 3 is disposed to be movable in an up-and-down direction with respect to the upper unit 2. In other words, distance between the upper and lower units 2 and 3 is variable. For example, at least one elastic member may be disposed between the upper and lower units 2 and 3.

The electric motor 4 is supported by the lower unit 3. Specifically, the electric motor 4 is supported by the frame 31 of the lower unit 3. The electric motor 4 is configured to drive the drive wheels 32. The electric motor 4 may be supplied with electricity from a battery (omitted in illustration).

The link mechanism 5 includes a first link 51, a second link 52, a third link 53, a fourth link 54, a first joint 55, and a second joint 56. Besides, the link mechanism 5 includes a third joint 57 and a fourth joint 58.

The first link 51 is pivotably attached to the upper unit 2. Specifically, the first link 51 is attached at the upper end thereof to the upper unit 2. The upper end of the first link 51 is configured to move with the upper unit 2 in the up-and-down direction.

The first link 51 extends from the upper unit 2 both downward and in the second direction. In other words, the lower end of the first link 51 is disposed on the second-directional side of the upper end of the first link 51.

The first link 51 is pivotable about a first pivot axis O1. Specifically, the first link 51 can be pivoted about the first pivot axis O1 in both the first and second directions. When the first link 51 is pivoted in the first direction, the lower end thereof is moved in the first direction. In other words, the first link 51 can be pivoted counterclockwise about the first pivot axis O1 in FIG. 1. When the first link 51 is pivoted in the second direction, the lower end thereof is moved in the second direction. In other words, the first link 51 can be pivoted clockwise about the first pivot axis O1 in FIG. 1.

The second link 52 is pivotably attached to the lower unit 3. Specifically, the second link 52 is attached at the lower end thereof to the lower unit 3. Additionally, the second link 52 is attached to a member, amongst the constituent members of the lower unit 3, that moves up and down with the drive wheels 32. The lower end of the second link 52 is configured to move with the lower unit 3 in the up-and-down direction. It should be noted that in the presently preferred embodiment, the second link 52 is attached to a shaft supporting the drive wheels 32.

The second link 52 extends from the lower unit 3 both upward and in the second direction. In other words, the upper end of the second link 52 is disposed on the second-directional side of the lower end thereof.

The second link 52 is pivotable about a second pivot axis O2. Specifically, the second link 52 can be pivoted about the second pivot axis O2 in both the first and second directions. When the second link 52 is pivoted in the first direction, the upper end thereof is moved in the first direction. In other words, the second link 52 can be pivoted clockwise about the second pivot axis O2 in FIG. 1. When the second link 52 is pivoted in the second direction, the upper end thereof is moved in the second direction. In other words, the second link 52 can be pivoted counterclockwise about the second pivot axis O2 in FIG. 1.

The first joint 55 connects the first and second links 51 and 52 to each other. Specifically, the first joint 55 connects the lower end of the first link 51 and the upper end of the second link 52 to each other. It should be noted that the first and second links 51 and 52 are rotatably connected to each other through the first joint 55.

The first joint 55 is disposed on the second-directional side of an imaginary line L connecting the first and second pivot axes O1 and O2. The first joint 55 is disposed to be movable in both the first and second directions. When the first joint 55 is moved in the first direction, i.e., toward the imaginary line L, the first and second pivot axes O1 and O2 move apart from each other. It should be noted that the first joint 55 is not moved across the imaginary line L in the first direction.

The third link 53 is pivotably attached to the upper unit 2. Specifically, the third link 53 is attached at the upper end thereof to the upper unit 2. The upper end of the third link 53 is configured to move with the upper unit 2 in the up-and-down direction.

The third link 53 extends from the upper unit 2 both downward and in the first direction. In other words, the lower end of the third link 53 is disposed on the first-directional side of the upper end thereof.

The third link 53 is pivotable about the first pivot axis O1. Specifically, the third link 53 can be pivoted about the first pivot axis O1 in both the first and second directions. When the third link 53 is pivoted in the first direction, the lower end thereof is moved in the first direction. In other words, the third link 53 can be pivoted counterclockwise about the first pivot axis O1 in FIG. 1. When the third link 53 is pivoted in the second direction, the lower end thereof is moved in the second direction. In other words, the third link 53 can be pivoted clockwise about the first pivot axis O1 in FIG. 1.

The fourth link 54 is pivotably attached to the lower unit 3. Specifically, the fourth link 54 is attached at the lower end thereof to the lower unit 3. Additionally, the fourth link 54 is also attached to the member, amongst the constituent members of the lower unit 3, that moves up and down with the drive wheels 32. The lower end of the fourth link 54 is configured to move up and down with the lower unit 3. It should be noted that in the presently preferred embodiment, the fourth link 54 is attached to the shaft supporting the drive wheels 32.

The fourth link 54 extends from the lower unit 3 both upward and in the first direction. In other words, the upper end of the fourth link 54 is disposed on the first-directional side of the lower end thereof.

The fourth link 54 is pivotable about the second pivot axis O2. Specifically, the fourth link 54 can be pivoted about the second pivot axis O2 in both the first and second directions. When the fourth link 54 is pivoted in the first direction, the upper end thereof is moved in the first direction. In other words, the fourth link 54 can be pivoted clockwise about the second pivot axis O2 in FIG. 1. When the fourth link 54 is pivoted in the second direction, the upper end thereof is moved in the second direction. In other words, the fourth link 54 can be pivoted counterclockwise about the second pivot axis O2 in FIG. 1.

The second joint 56 connects the third and fourth links 53 and 54 to each other. Specifically, the second joint 56 connects the lower end of the third link 53 and the upper end of the fourth link 54 to each other. It should be noted that the third and fourth links 53 and 54 are rotatably connected to each other through the second joint 56.

The second joint 56 is disposed on the first-directional side of the imaginary line L connecting the first and second pivot axes O1 and O2. The second joint 56 is disposed to be movable in both the first and second directions. When the second joint 56 is moved in the second direction, i.e., toward the imaginary line L, the first and second pivot axes O1 and O2 move apart from each other. It should be noted that the second joint 56 is not moved across the imaginary line L in the second direction.

The third joint 57 connects the first and third links 51 and 53 to each other. Specifically, the third joint 57 connects the upper end of the first link 51 and that of the third link 53 to each other. It should be noted that the first and third links 51 and 53 are rotatably connected to each other via the third joint 57.

The third joint 57 is disposed in the identical position to the first pivot axis O1. The third joint 57 is attached to the upper unit 2 to move with it in the up-and-down direction.

The fourth joint 58 connects the second and fourth links 52 and 54 to each other. Specifically, the fourth joint 58 connects the lower end of the second link 52 and that of the fourth link 54 to each other. It should be noted that the second and fourth links 52 and 54 are rotatably connected to each other via the fourth joint 58.

The fourth joint 58 is disposed in the identical position to the second pivot axis O2. The fourth joint 58 is attached to the lower unit 3 to move with it in the up-and-down direction.

The operating member 6 is disposed adjacent to the link mechanism 5 in the axial direction (perpendicular to the drawing of FIG. 1). The operating member 6 is configured to operate the link mechanism 5. Additionally, the operating member 6 is configured to receive a human drive force inputted to it by the user in either the first or second direction. For example, a handle to be held by the user is attached to the distal end of the operating member 6. When the user pulls the operating member 6 in the first direction to make the cart 200 travel in the first direction, the human drive force is inputted to the operating member 6 in the first direction. On the other hand, when the user pushes the operating member 6 in the second direction to make the cart 200 travel in the second direction, the human drive force is inputted to the operating member 6 in the second direction.

The operating member 6 is configured to move the first joint 55 in the first direction when the human drive force is inputted thereto in the first direction. Specifically, the operating member 6 includes a first contact surface 61. The first contact surface 61 faces the first direction. The operating member 6 includes a slit hole 60 extending along the first and second directions. Of the inner wall surfaces that define the slit hole 60A, the one facing the first direction corresponds to the first contact surface 61.

The first contact surface 61 is opposed to either the first joint 55 or a member that moves with the first joint 55 in the first direction. For example, the first joint 55 axially extends from either the first or second link 51, 52. Besides, the first joint 55 is disposed in part within the slit hole 60 of the operating member 6.

The operating member 6 is configured to move the second joint 56 in the second direction when the human drive force is inputted thereto in the second direction. Specifically, the operating member 6 includes a second contact surface 62. The second contact surface 62 faces the second direction. Of the inner wall surfaces that define the slit hole 60, the one facing the second direction corresponds to the second contact surface 62.

The second contact surface 62 is opposed to either the second joint 56 or a member that moves with the second joint 56 in the second direction. For example, the second joint 56 axially extends from either the third or fourth link 53, 54. Besides, the second joint 56 is disposed in part within the slit hole 60 of the operating member 6.

The drive unit 100 configured as described above operates as follows. First, when intending to make the cart 200 travel in the first direction, the user pulls the operating member 6 in the first direction. Accordingly, the human drive force oriented in the first direction is inputted to the operating member 6, whereby the first contact surface 61 contacts the first joint 55.

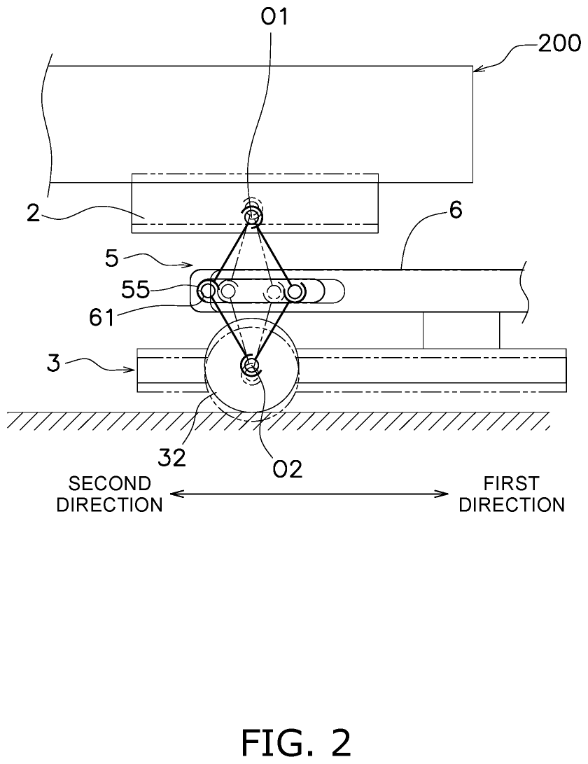

Suppose that the first and second pivot axes O1 and O2 are freely movable. As depicted with dashed two-dotted line in FIG. 2, when the first joint 55 is moved in the first direction, the first and second pivot axes O1 and O2 move apart from each other, whereby the upper and lower units 2 and 3 move apart from each other.

However, in fact, the upper and lower units 2 and 3 are interposed between the road surface and the cart 200; hence, when the user pulls the operating member 6 in the first direction, a force by which the upper unit 2 is pressed onto the cart 200 and a force by which the lower unit 3 is pressed onto the road surface are generated. Because of this, a wheel pressure is enabled to act on the drive wheels 32. When the cart 200 is heavy, the force required for the user to pull the operating member 6 in the first direction is increased in magnitude; hence, the wheel pressure acting on the drive wheels 32 is increased in magnitude as well. On the other hand, when the cart 200 is lightweight, the force required for the user to pull the operating member 6 in the first direction is reduced in magnitude; hence, the wheel pressure acting on the drive wheels 32 is reduced in magnitude as well. Thus, the drive unit 100 is enabled to change the magnitude of the wheel pressure acting on the drive wheels 32 in accordance with the weight of the cart 200.

On the other hand, when intending to make the cart 200 travel in the second direction, the user pushes the operating member 6 in the second direction. Accordingly, the human drive force oriented in the second direction is inputted to the operating member 6, whereby the second contact surface 62 contacts the second joint 56.

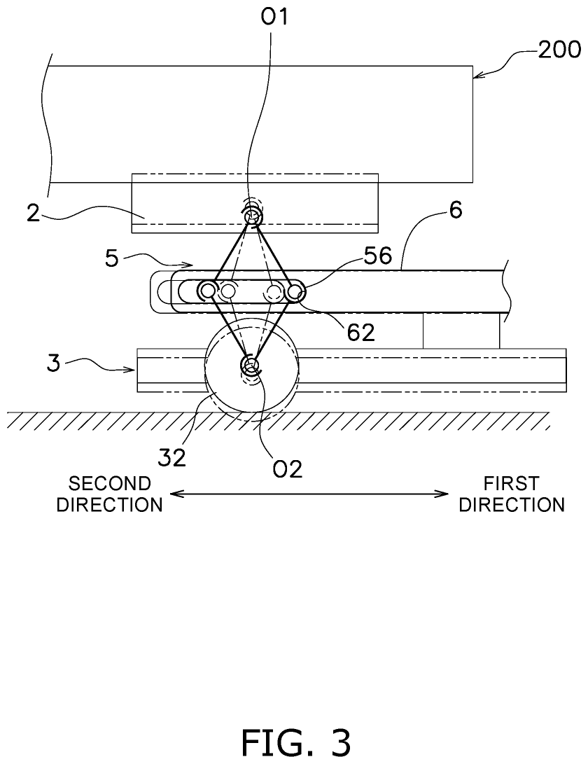

Suppose the first and second pivot axes O1 and O2 are freely movable. As depicted with dashed two-dotted line in FIG. 3, when the second joint 56 is moved in the second direction, the first and second pivot axes O1 and O2 move apart from each other, whereby the upper and lower units 2 and 3 move apart from each other.

However, in fact, the upper and lower units 2 and 3 are interposed between the road surface and the cart 200; hence, when the user pushes the operating member 6 in the second direction, a force by which the upper unit 2 is pressed onto the cart 200 and a force by which the lower unit 3 is pressed onto the road surface are generated. Because of this, the wheel pressure is enabled to act on the drive wheels 32. When the cart 200 is heavy, the force required for the user to push the operating member 6 in the second direction is increased in magnitude; hence, the wheel pressure acting on the drive wheels 32 is increased in magnitude as well. On the other hand, when the cart 200 is lightweight, the force required for the user to push the operating member 6 in the second direction is reduced in magnitude; hence, the wheel pressure acting on the drive wheels 32 is reduced in magnitude as well. Thus, similarly when the cart 200 is intended to travel in the second direction, the drive unit 100 is enabled to change the wheel pressure acting on the drive wheels 32 in accordance with the weight of the cart 200.

### [Modifications]

One preferred embodiment of the claimed invention has been explained above. However, embodiments of the claimed invention are not limited to the above, and a variety of changes can be made without departing from the scope of the claimed invention. It should be noted that, basically speaking, respective modifications to be described are applicable simultaneously.

(a) In the preferred embodiment described above, the pivot axis O1 of the first link 51 and that of the third link 53 are identical to each other but may be different from each other. For example, the pivot axis of the third link 53 may be disposed on the first-directional side of that of the first link 51. Likewise, the pivot axis of the second link 52 and that of the fourth link 54 may be different from each other. For example, the pivot axis of the fourth link 54 may be disposed on the first-directional side of that of the second link 52. In this case, the link mechanism 5 may not include the third and fourth joints 57 and 58.

(b) In the preferred embodiment described above, the link mechanism 5 includes the first to fourth links 51 to 54; however, the link mechanism 5 is not limited in configuration to this. For example, the link mechanism 5 may include the first and second links 51 and 52 without including the third and fourth links 53 and 54.

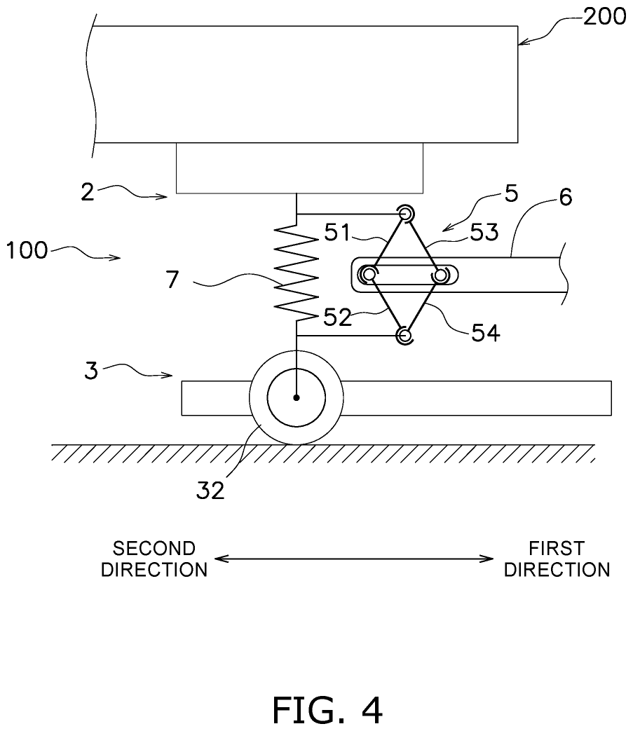

(c) As shown in FIG. 4, the drive unit 100 may include an urging member 7. The urging member 7 urges the upper and lower units 2 and 3 apart from each other. For example, the urging member 7 is a compression spring. The urging member 7 applies an initial load to the drive wheels 32. It should be noted that the first and third links 51 and 53 are pivotably attached to part of the upper unit 2. On the other hand, the second and fourth links 52 and 54 are pivotably attached to part of the lower unit 3.

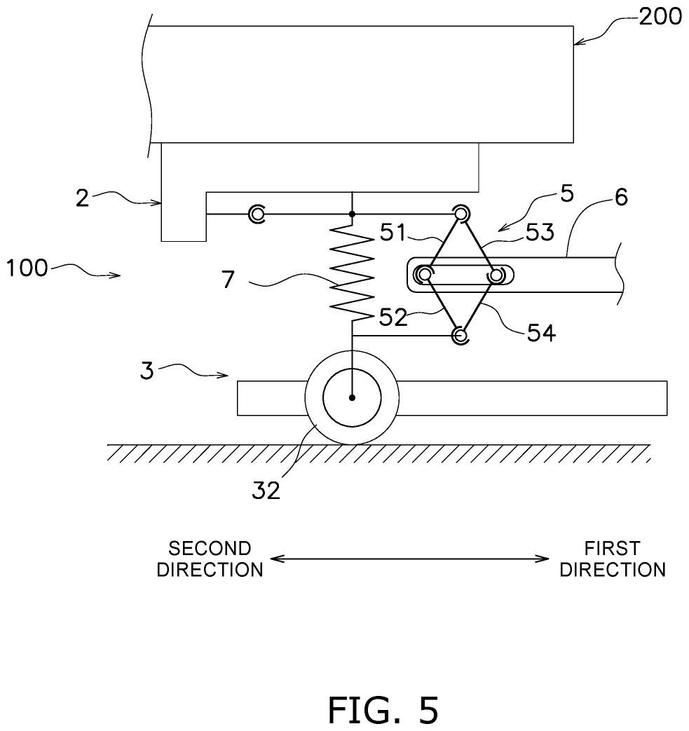

When the drive unit 100 includes the urging member 7 as described above, the drive unit 100 may be configured, as shown in FIG. 4, such that the link mechanism 5 and the urging member 7 are identical to each other in amount of compression and expansion in the up-and-down direction; alternatively, the drive unit 100 may be configured, as shown in FIG. 5, such that the link mechanism 5 and the urging member 7 are different from each other in amount of compression and expansion in the up-and-down direction.

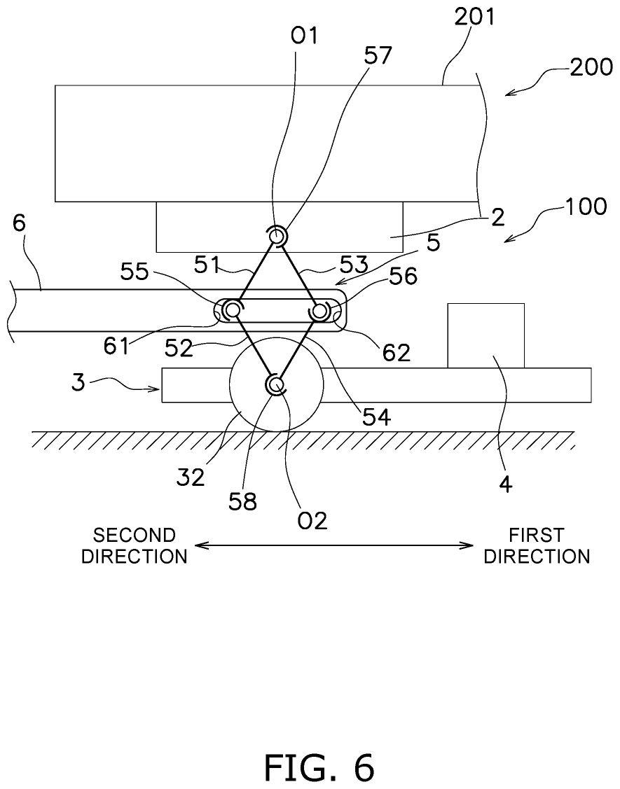

(d) The preferred embodiment described above has explained the method of using the drive unit 100 as follows: the drive unit 100 is towed for traveling in the first direction; on the other hand, the drive unit 100 is pushed for traveling in the second direction. However, the method of using the drive unit 100 is not limited to this. For example, as shown in FIG. 6, the user may be located on the second-directional side of the drive unit 100. In this case, the operating member 6 extends from the link mechanism 5 in the second direction. Then, the drive unit 100 is towed for traveling in the second direction; on the other hand, the drive unit 100 is pushed for traveling in the first direction.

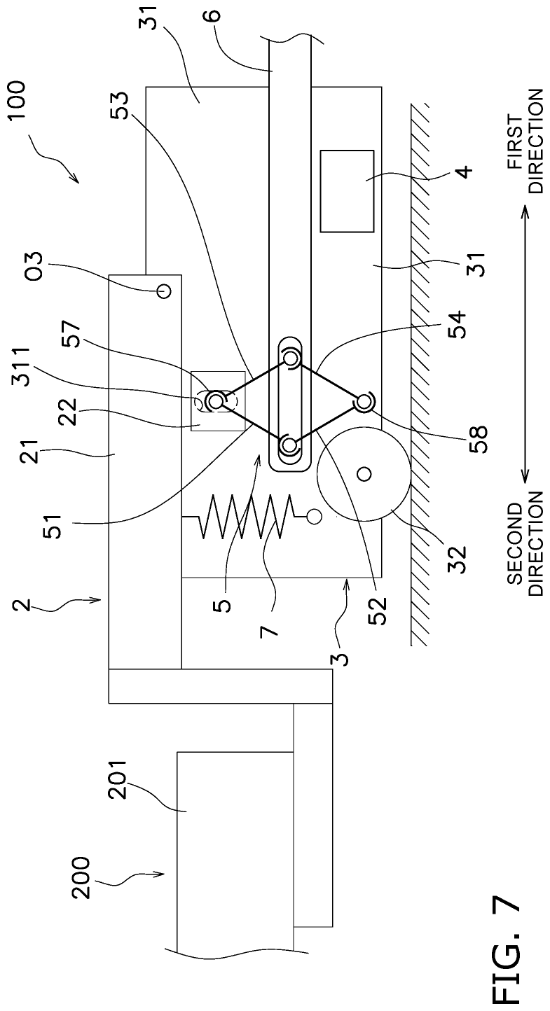

(e) As shown in FIG. 7, the upper unit 2 may include a body 21 and an attachment portion 22. The body 21 is attached to the lower unit 3 to be pivotable about a third pivot axis O3 in the up-and-down direction. When the body 21 is thus pivoted in the up-and-down direction with respect to the lower unit 3, the upper and lower units 2 and 3 are made pivotable in the up-and-down direction with respect to each other.

The attachment portion 22 is movable in the up-and-down direction with respect to the body 21. The first and third links 51 and 53 are pivotably attached to the attachment portion 22. The upper ends of the first and third links 51 and 53 are moved unitarily with the attachment portion 22 in the up-and-down direction. Besides, the upper ends of the first and third links 51 and 53 are supported by the lower unit 3 to be movable up and down. Specifically, the lower unit 3 includes a frame 31 provided with a groove 311 extending in the up-and-down direction. The third joint 57 is disposed within the groove 311 to be movable in the up-and-down direction.

(f) As shown in FIG. 7, the drive wheel 32 might not be disposed below the cart 200. In this case, the upper unit 2 extends toward the cart 200.

(g) As shown in FIG. 7, the urging member 7 may be attached to the frame 31 and may urge the drive wheel 32 through the frame 31. Additionally, the lower ends of the second and fourth links 52 and 54 may be pivotably attached to the frame 31.

### LIST OF REFERENCE NUMERALS

2: Upper unit, 3: Lower unit, 32: Drive wheel, 4: Electric motor, 5: Link mechanism, 51: First link, 52: Second link, 53: Third link, 54: Fourth link, 55: First joint, 56: Second joint, 6: Operating member, 61: First contact surface, 62: Second contact surface, 7: Urging member, 100: Drive unit

What is claimed is:

1. A drive unit configured to be attached to a mobile object capable of traveling in a first direction, the drive unit comprising:
an upper unit configured to be attached to the mobile object;
a lower unit including a drive wheel, the lower unit disposed to be movable in an up-and-down direction with respect to the upper unit;
a drive source configured to drive the drive wheel;
a link mechanism including a first link, a second link, and a first joint, the first link pivotably attached to the upper unit, the first link extending from the upper unit both downward and in a second direction oriented opposite to the first direction, the second link pivotably attached to the lower unit, the second link extending from the lower unit both upward and in the second direction, the first joint connecting the first and second links to each other; and
an operating member configured to move the first joint in the first direction when a human drive force is inputted thereto in the first direction.

2. The drive unit according to claim 1, wherein
the link mechanism includes
a third link pivotably attached to the upper unit, the third link extending from the upper unit both downward and in the first direction,
a fourth link pivotably attached to the lower unit, the fourth link extending from the lower unit both upward and in the first direction, and
a second joint connecting the third and fourth links to each other, and
the operating member is configured to move the second joint in the second direction when the human drive force is inputted thereto in the second direction.

3. The drive unit according to claim 1, further comprising:
an urging member urging the upper and lower units apart from each other.

4. The drive unit according to claim 1, wherein
the operating member includes a first contact surface oriented in the first direction, and
the first contact surface opposes either the first joint or a member unitarily moved with the first joint in the first direction.

5. The drive unit according to claim 2, wherein
the operating member includes a second contact surface oriented in the second direction, and
the second contact surface opposes either the second joint or a member unitarily moved with the second joint in the second direction.
